(19) United States
(12) Patent Application Publication
(10) Pub. No.: US 2011/0314972 A1
(43) Pub. Date: Dec. 29, 2011

(54) Hydraulic Torque Wrench for Tight Clearance

(75) Inventors: Kenneth C. Rickley, III, Houston, TX (US); Peter Armstrong, Strongville, OH (US)

(73) Assignee: TITAN TECHNOLOGIES INTERNATIONAL, INC., Houston, TX (US)

(21) Appl. No.: 13/023,375

(22) Filed: Feb. 8, 2011

Related U.S. Application Data
(60) Provisional application No. 61/302,910, filed on Feb. 9, 2010.

(51) Int. Cl. B25B 21/00; B25B 13/46

(52) U.S. Cl. 81/57.39; 81/57.44

(57) ABSTRACT

A hydraulic torque wrench has a support partially sandwiched between first and second side plates. The support has hoop that extends beyond the edges of the plates so that the hoop has a smaller width than the wrench. An inner surface of the hoop defining a groove that receives a rib of a lever that fits against the hoop. This lever has an internal opening in which a socket disposes. A segment movable segment on the lever has teeth that ratchet with teeth around the socket. As the lever is reciprocated back and forth by an actuator on the wrench, the ratcheting between the lever and socket turn the socket and any nut disposed therein. The arrangement of the hoop, socket, and lever enable the wrench to be used in locations around nuts having tight clearances.

### CROSS-REFERENCE TO RELATED APPLICATIONS

This is a non-provisional of U.S. Provisional Appl. Ser. No. 61/302,910, filed 9 Feb. 2010, which is incorporated herein by reference and to which priority is claimed.

### BACKGROUND

Nuts used to connect flanges for piping and other forms of tubing need to have high, precise levels of torque applied. To tighten and loosen such nuts, operators may use a hydraulic torque wrench as known in the art. FIGS. 1A-1C show perspective, side, and front views of a hydraulic torque wrench 10 according to the prior art.

In general, the wrench 10 has an actuator 20 and a ratchet linkage 30. Typically, these two components 20/30 are modular so they can be coupled and decoupled depending on their desired use. Although not shown, the actuator 20 has a hydraulic cylinder and piston. With the actuator 20 installed on the linkage 10, a free end of the actuator's piston pivotally connects to a drive lever (not shown) inside the linkage. As the piston moves reciprocally, it pushes this drive lever back and forth. In turn, a ratchet mechanism (not shown) between the drive lever and a socket 40 causes the socket 40 to rotate and apply torque to a nut (not shown) disposed in the socket 40.

Although the operation of such torque wrenches is effective, existing torque wrenches in the art have a similar design for the ratchet linkage 30. As shown in FIGS. 1A-1C, the linkage 30 has side plates 32/34 that sandwich internal components of the linkage 30, and spacers 38 can be used between the plates 32/34. A socket 40 installs in between these plates 32/34 and remains exposed through openings 35 in the plates. This socket 40 fits on a nut to be turned, and internal drive lever and ratchet mechanism (not shown) held between the plates 32/34 couple to the socket 40 so it can be turned.

As shown, the socket 40 is held by the plates 32/34 and sleeves 45 may be disposed in between the plate's openings 35 and socket 40 to help retain the socket 40. A shroud 32 of thin metal attaches around the outside of the socket 40 and the edges of the side plates 32/34 to hide internal components therein.

Such conventional hydraulic torque wrenches can operate with pressure levels ranging as high as about 700 bar (˜10,000 psi) and can produce torque levels ranging to from 200 fl-lb (270 n-m) to as high as about 35,000 ft-lb (49,000 n-m). Due to such levels, the components of the hydraulic torque wrench must be designed with suitable materials and robustness that limits the resulting design of the wrench. For example, components of the wrench may be made from aircraft grade, high strength alloys having suitable stress and fatigue resistant properties. In addition to dictating material characteristics, the limitations caused by the wrench's high-pressure operation have lead to some common features shared among the various hydraulic torque wrenches available in the art from such companies as Titan Technologies International, Orione Hydro Power, Rapid-Torc, Hytorc, TorcUp, and Bolttech.

Although common in the industry, this form of construction for the hydraulic torque wrench has limitations. As best shown in FIG. 1A, for example, the torque wrench's construction increases the overall width W of the wrench 10, which may limit the usefulness of the wrench 10 in some situations. The overall width W can range from 1.25 in (31.75 mm) to 2.8 in (71.12 mm), depending of course on the model size of the wrench and the socket size the wrench is designed to use.

For reference, FIG. 2 diagrams a typical arrangement 50 where the wrench 10 may be used to tighten or loosen a nut 62. As shown, a bolt 66 passes through two flanges 52/54, and upper and lower nuts 62/64 thread onto the bolt 66 to hole the flanges 52/54 together. In some circumstances, an obstruction 56 may lie in close proximity to the flanges 52/54. This can lead to a reduced height clearance H between the flange 52, nut 62, and exposed end of the bolt 66 that can limit access of a conventional hydraulic torque wrench 10 onto the nut 62. In addition, a feature (diameter change, shoulder, sidewall, chamfer, etc.) close to the nut 62 on the flange 52 may reduced a depth clearance D around the nut 62 that can limit access of the conventional hydraulic torque wrench 10.

Accordingly, what is needed in a hydraulic torque wrench capable of use in tight clearances to improve access of the wrench to nuts and increase the wrench's usefulness in the field.

### SUMMARY

A hydraulic torque wrench has a support partially sandwiched between first and second side plates. The support has hoop that extends beyond the edges of the plates so that the hoop has a smaller width than the wrench. An inner surface of the hoop defining a groove that receives a rib of a lever that fits against the hoop. This lever has an internal opening in which a socket disposes. A segment movable segment on the lever has teeth that ratchet with teeth around the socket. As the lever is reciprocated back and forth by an actuator on the wrench, the ratcheting between the lever and socket turn the socket and any nut disposed therein. The arrangement of the hoop, socket, and lever enable the wrench to be used in locations around nuts having tight clearances.

The foregoing summary is not intended to summarize each potential embodiment or every aspect of the present disclosure.

### BRIEF DESCRIPTION OF THE DRAWINGS

FIGS. 1A-1C show perspective, side, and front views of a hydraulic torque wrench according to the prior art.

FIG. 2 diagrams a typical nut location subject to tight clearances.

FIGS. 3A-3C show perspective, side, and front views of a hydraulic torque wrench according to the present disclosure.

FIG. 4 shows a side view of the hydraulic torque wrench with one of the side plates removed.

FIGS. 5A-5B shows an isolated and exploded views of hydraulic torque wrench components.

FIG. 6 shows an arrangement for retaining the socket in the lever of the disclosed wrench.

FIGS. 7A-7B show additional views of the ratchet linkage for the disclosed wrench.

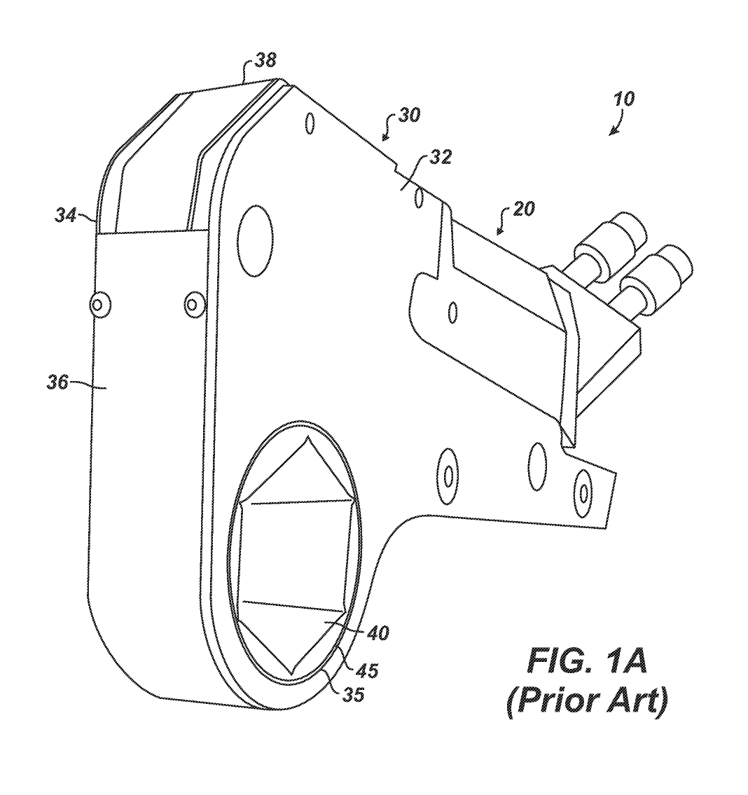

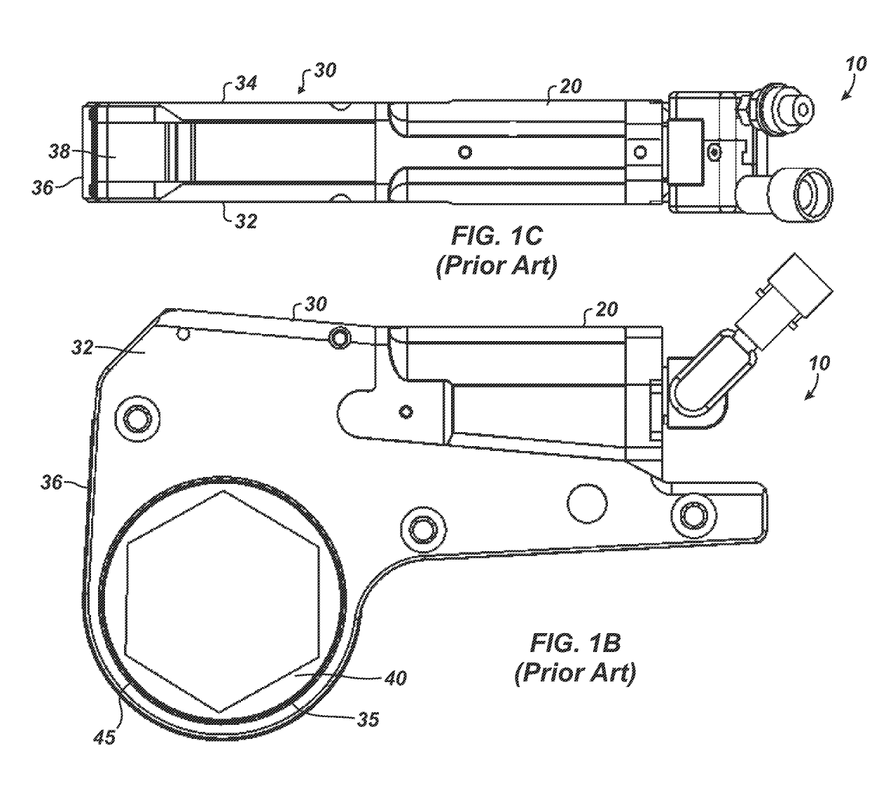

### DETAILED DESCRIPTION

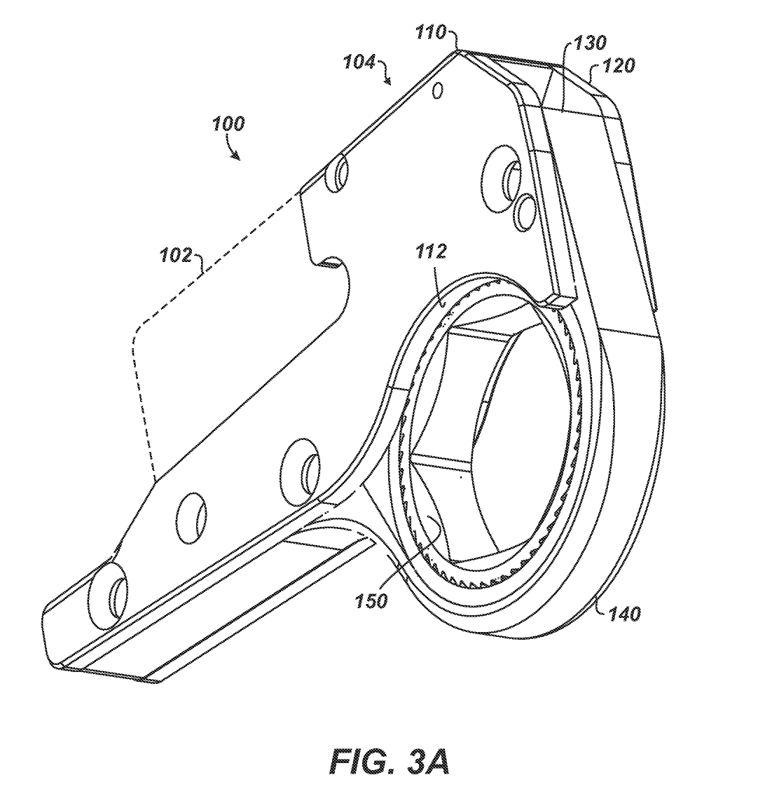

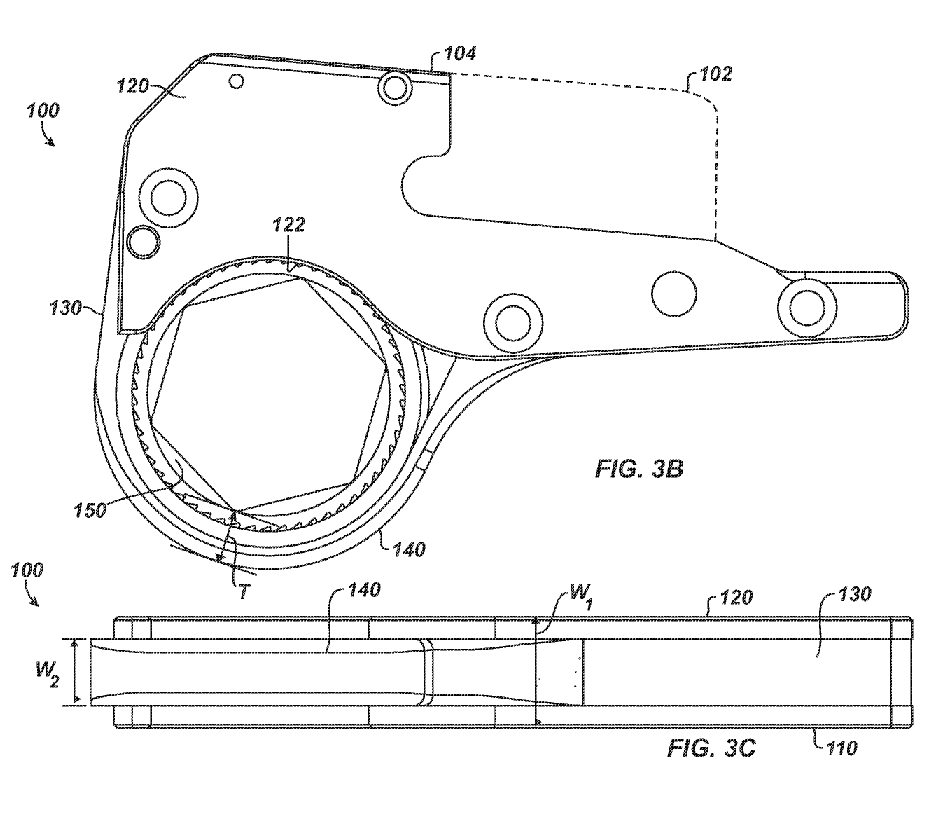

FIGS. 3A-3C show perspective, side, and front views of a hydraulic torque wrench 100 according to the present disclosure. The wrench 100 has an actuator 102 and a ratchet linkage 104 that can be coupled and decoupled together. As noted previously, the actuator 102 has a hydraulic cylinder and a piston (not shown) with operation similar to that known in the art.

The ratchet linkage 104 has side plates 110/120 sandwiching a spacer 130 other internal components described latter. In contrast to the conventional ratchet linkage design, the side plate 110/120 do not extend all the around the socket 150 to hold the socket 150 in the linkage 100. Instead, as shown, the spacer 130 forms a hoop 140 that wraps around the outside of the socket 150 for holding it in the linkage 100.

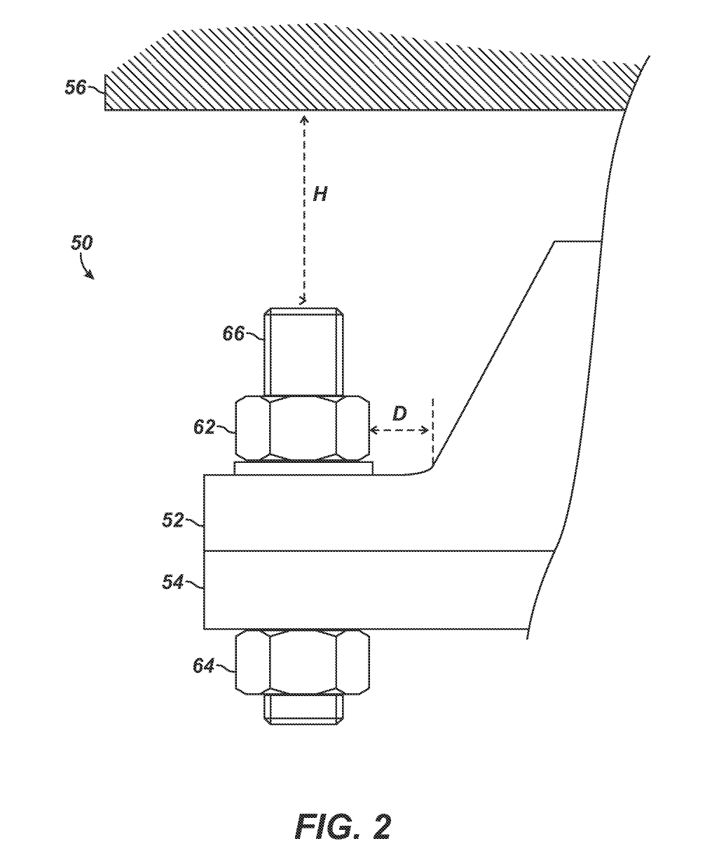

As best shown in FIG. 3C, this hoop 140 has a width roughly the same as the spacer 130 held between the plates 110/120. Accordingly, the hoop 140 has a substantially thinner width W₂ than the overall width W₁ of the linkage 100. This provides advantages for using the wrench 100 in locations having a tight clearance. For example, as described with reference to FIG. 2, the thinner width W₂ of the hoop 140 may allow the wrench 100 to fit in tighter height clearances H between an obstruction and the flange, nut, and/or bolt.

As best shown in FIG. 3B, this hoop 140 can still have a thin, uniform thickness T around the outside of the socket 150. This thickness T also provides advantages for using the wrench 100 in locations having a tight clearance. For example, as described with reference to FIG. 2, the thickness T of the hoop 140 may allow the wrench 100 to fit in tighter depth clearances D around a nut.

For reference, a typical torque wrench for NF size hex nuts of ¾ to 2⅜ in may have an overall width of 1¼ in. By contrast, the disclosed hydraulic torque wrench 100 for the same size may have a hoop 140 with a width of about ¾ in. Likewise, a typical torque wrench for NF size hex nuts of ⅞ to 3⅛ may have an overall width of 1⅝ in. By contrast, the disclosed hydraulic torque wrench 100 for the same size may have a hoop 140 with a width of about 1⅛ in.

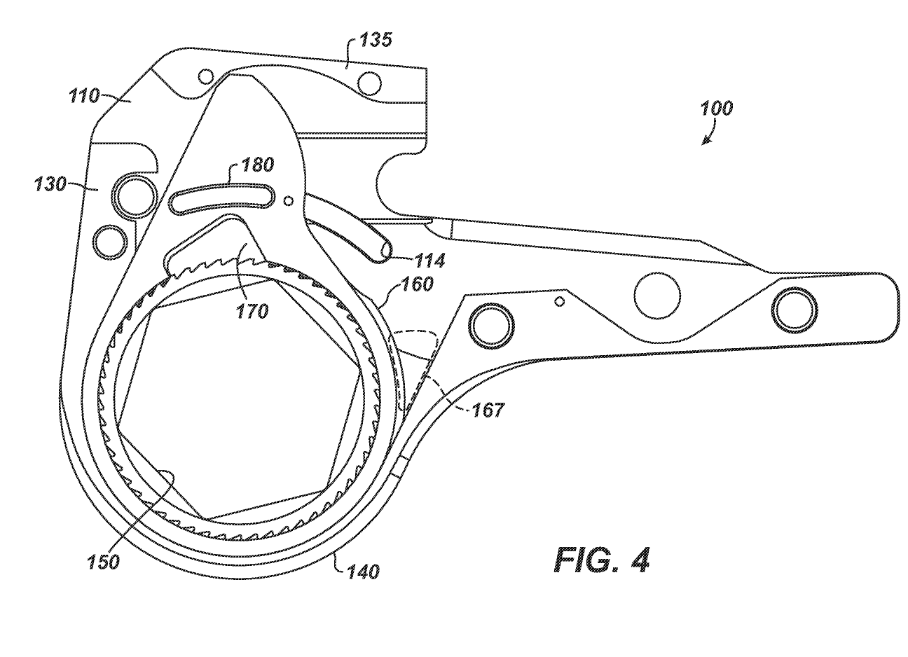

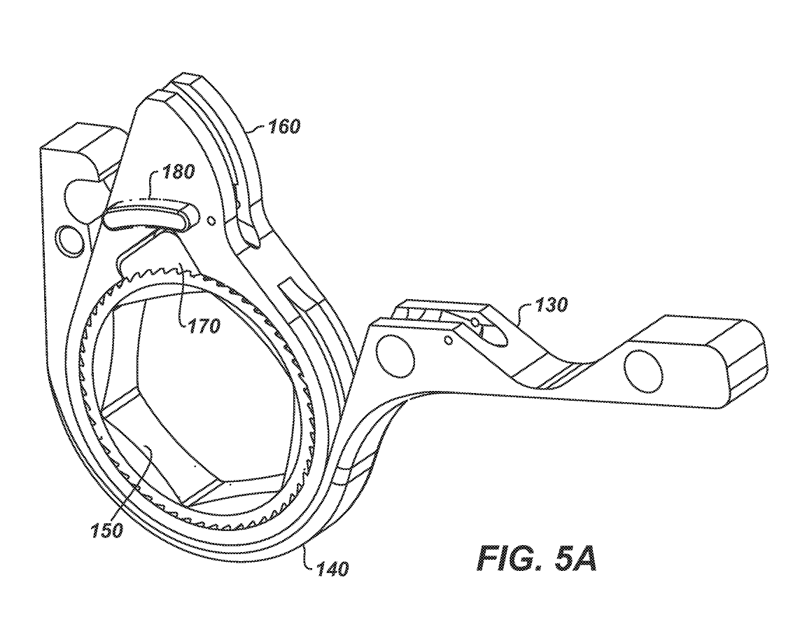

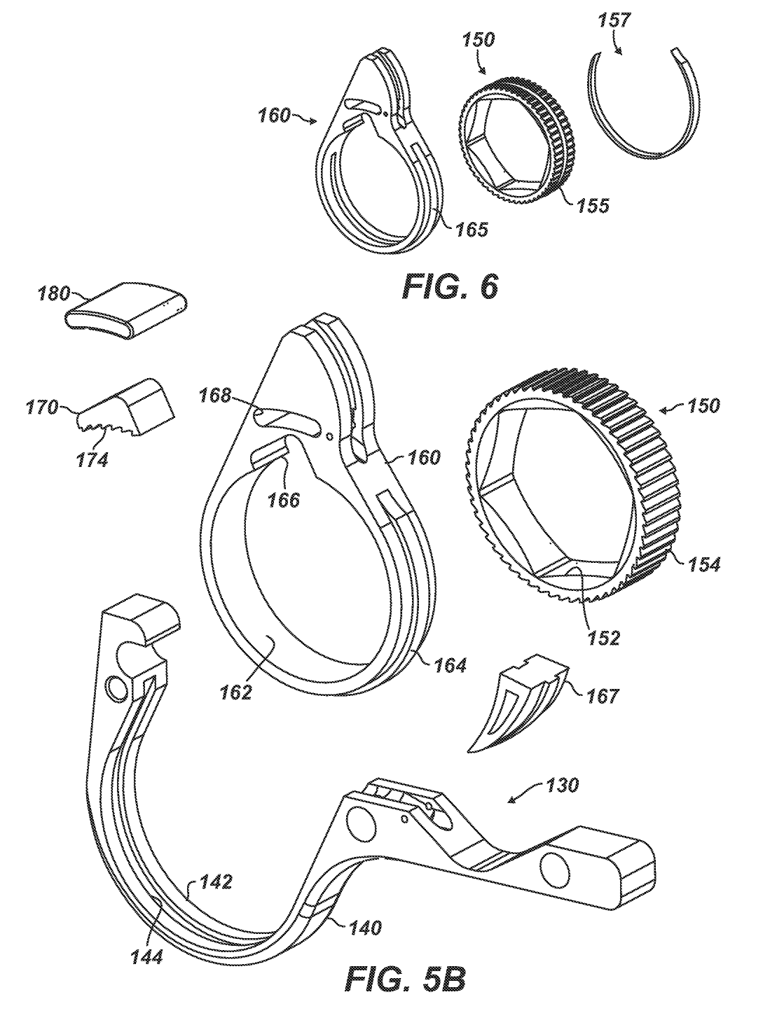

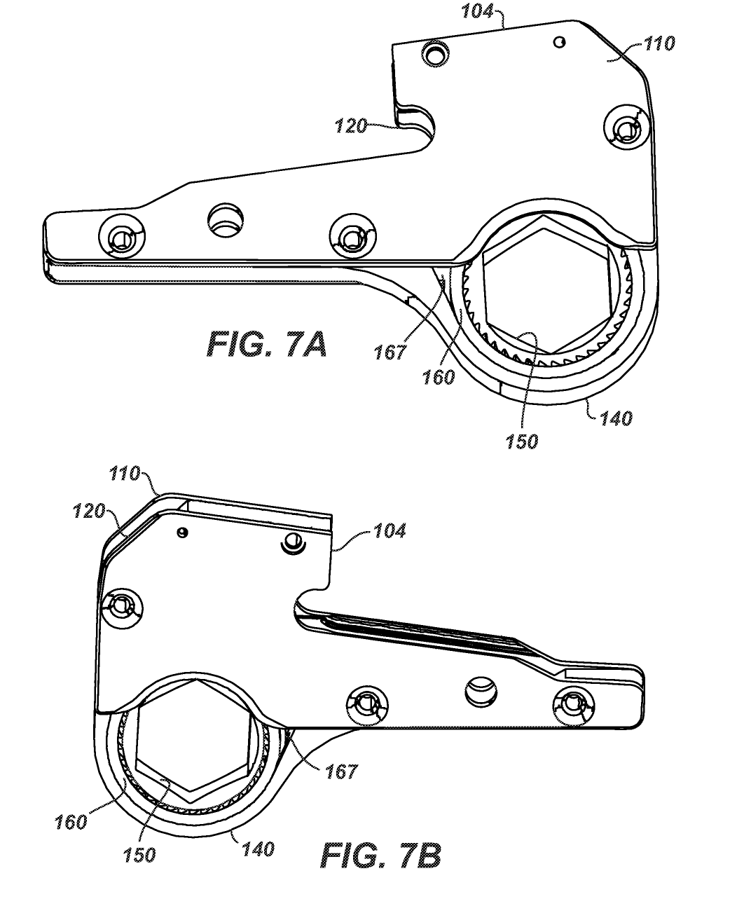

Internal details of the ratchet linkage 102 are provided in FIGS. 4 and 5A-5B. FIGS. 7A-7B also show additional views of the ratchet linkage 102 for the disclosed wrench.

Internally, the linkage 102 has the spacer 130, socket 150, drive lever 160, drive segment 170, and drive pin 180. The drive pin 180 fits in a slot 168 in the drive lever 160 and fits in a corresponding slot (e.g., 114; FIG. 4) of the side plates (e.g., 110). The drive lever 160 has an end 165 for coupling to piston components of the actuator (not shown).

Internally, the lever 160 defines an opening 162 for the socket 150, a pocket 166 for the drive segment 170, and an outer rib 164 for the hoop 140. In particular, the socket 150 having its internal hex 152 and external ratchet teeth 154 fits inside the lever's opening 162, and the drive segment 170 fits into the lever's pocket 166. Teeth 174 on the segment 170 can mate with the socket's teeth, and the segment can move in the pocket 166, which provides the ratcheting mechanism between the lever 160 and the socket 150 as the lever 160 reciprocates back and forth.

The lever's outside surface fits against an inner surface 142 of the hoop 140, and the lever's rib 164 fits into a groove 144 defined around the hoop's inner surface 142. As best shown in FIGS. 4 and 7A-7B, a wedge 167 or other type of support may be positioned between the lever 160 and the hoop 140 to support the lever 160 therein as it reciprocates. This wedge 167 can include a rib and groove to help mate between the lever's rib 164 and the hoop's groove 142.

Engagement between the rib 164 and groove 144 helps support the lever 160 and socket 150 and control the reciprocal movement of the lever 160 in the hoop 140. Although the hoop, lever, or some spacer could be used to hold the socket 150, use of such techniques is less preferred because they could increase the width of the hoop 140. Instead, in one arrangement, internal edges (112/122; FIGS. 3A-3B) on the side plates 110/120 may retain part of the socket 150.

In addition to this or in the alternative, the inside surface of the lever's opening 162 and the outside surface 154 of the socket 150 can have a feature to retain the socket 150 in the lever 160. For example, a locking key arrangement can be used as shown in FIG. 6. The socket 150 defines an outer groove 155 around its circumference, and the lever 160 defines a slot 165 around its circumference. When the socket 150 positions in the lever, the groove 155 aligns with the slot 165, and a snap ring 157 or the like fits in the groove 155 and slot 165 to hold the socket 150. When the lever 160 is then positioned in the hoop 140, portion of the snap ring 157 extending outside the lever's slot 165 can fit in the hoop's groove 144.

If feasible for the assembly and disassembly of the wrench, the outside surface of the lever 160 can having its integral rim 164 as shown in FIG. 5B. Likewise, the inside surface 162 of the lever 160 can include an integral rib (not shown) that engages in a circumferential groove on the socket 150 as with the groove 155 on the socket of FIG. 6. However, the socket 150 in such an arrangement must be able to install in the lever 160, which can be done during assembly and may or may not be capable of disassembly. These and other forms of locking arrangements could be used to retain the socket 150 in the lever 160 and retain the lever 160 in the hoop 140.

Other details related to the disclosed hydraulic torque wrench can be found in U.S. Pat. Nos. 7,520,128; 6,546,839; and 6,311,585, which are incorporated herein by reference. The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A hydraulic torque wrench, comprising:
a body defining a hoop with an inner surface;
a lever defining an opening and having an outer surface, the lever rotatably disposed in the hoop of the body, the outer surface engaging the inner surface of the hoop and holding the lever in the hoop;
a socket rotatably disposed in the opening of the lever; and
a ratchet mechanism selectively transferring rotation of the lever to the socket.

2. The wrench of claim 1, wherein the lever comprises a pin disposed therein and engaged in slots in the body.

3. The wrench of claim 1, wherein the body comprises:
a support having first and second sides and defining the hoop;
first and second plates attached to the first and second sides of the support, the first and second plates each defining an edge beyond which the hoop of the support is exposed.

4. The wrench of claim 3, wherein the edges of the first and second plates engage portions of the socket and hold the socket in the lever.

5. The wrench of claim 3, wherein the hoop has a first width that is the same as a first width of the lever and that is less than a third width of the support and the first and second plates.

6. The wrench of claim 1, wherein the ratchet mechanism comprises a segment movably disposed in a pocket of the lever, the segment having first teeth engaging in one direction with second teeth disposed on the socket.

7. The wrench of claim 6, wherein the pocket of the lever wedges the segment against the socket when the lever rotates in the one direction and accommodates retraction of the segment away from the socket when the lever rotates in an opposite direction.

8. The wrench of claim 1, further comprising an actuator disposed on the body and coupling to the lever, the actuator reciprocating the lever between first and second positions and rotating the socket therein.

9. The wrench of claim 1, wherein the inner surface of the hoop defines a groove, and wherein the outer surface of the lever has a rib disposing the groove to hold the lever in the hoop.

10. The wrench of claim 1, wherein the inner surface of the hoop defines a first groove, and wherein the outer surface of the lever defines a slot with a ring disposed therein, the ring disposing in the first groove and holding the lever in the hoop.

11. The wrench of claim 10, wherein the socket defines a second groove disposed thereabout, the ring disposing in the second groove and holding the socket in the lever.

12. A hydraulic torque wrench, comprising:
a body defining a hoop, the hoop having an inner surface with a groove defined therein;
a lever defining an opening and having an outer surface with a rib disposed thereon, the lever rotatably disposed in the hoop of the body, the rib disposed in the groove and holding the lever in the hoop;
a socket rotatably disposed in the opening of the lever; and
a ratchet mechanism selectively transferring rotation of the lever to the socket.

13. The wrench of claim 12, wherein the lever comprises a pin disposed therein and engaged in slots in the body.

14. The wrench of claim 12, wherein the body comprises:
a support having first and second sides and defining the hoop;
first and second plates attached to the first and second sides of the support, the first and second plates each defining an edge beyond which the hoop of the support is exposed.

15. The wrench of claim 14, wherein the edges of the first and second plates engage portions of the socket and hold the socket in the lever.

16. The wrench of claim 14, wherein the hoop has a first width that is less than a second width of the support and the first and second plates.

17. The wrench of claim 12, wherein the ratchet mechanism comprises a segment movably disposed in a pocket of the lever, the segment having first teeth engaging in one direction with second teeth disposed on the socket.

18. The wrench of claim 17, wherein the pocket of the lever wedges the segment against the socket when the lever rotates in the one direction and accommodates retraction of the segment away from the socket when the lever rotates in an opposite direction.

19. The wrench of claim 12, further comprising an actuator disposed on the body and coupling to the lever, the actuator reciprocating the lever between first and second positions and rotating the socket therein.

20. A hydraulic torque wrench, comprising:
a body defining a hoop, the hoop having an inner surface with a first groove defined therein;
a lever defining an opening and having an outer surface with a slot defined therein, the lever rotatably disposed in the hoop of the body;
a socket rotatably disposed in the opening of the lever and having a second groove defined thereabout;
a ratchet mechanism selectively transferring rotation of the lever to the socket; and
a ring engaged in the first groove of the hoop, the slot in the lever, and second groove in the socket and holding the socket and lever in the hoop.

21. The wrench of claim 20, wherein the lever comprises a pin disposed therein and engaged in slots in the body.

22. The wrench of claim 20, wherein the body comprises:
a support having first and second sides and defining the hoop;
first and second plates attached to the first and second sides of the support, the first and second plates each defining an edge beyond which the hoop of the support is exposed.

23. The wrench of claim 22, wherein the edges of the first and second plates engage portions of the socket and hold the socket in the lever.

24. The wrench of claim 22, wherein the hoop has a first width that is less than a second width of the support and the first and second plates.

25. The wrench of claim 20, wherein the ratchet mechanism comprises a segment movably disposed in a pocket of the lever, the segment having first teeth engaging in one direction with second teeth disposed on the socket.

26. The wrench of claim 25, wherein the pocket of the lever wedges the segment against the socket when the lever rotates in the one direction and accommodates retraction of the segment away from the socket when the lever rotates in an opposite direction.

27. The wrench of claim 20, further comprising an actuator disposed on the body and coupling to the lever, the actuator reciprocating the lever between first and second positions and rotating the socket therein.
